(19) United States
(12) Patent Application Publication
(10) Pub. No.: US 2025/0260976 A1
(43) Pub. Date: Aug. 14, 2025

(54) SYSTEMS AND METHODS FOR ACCESSING CELLULAR NETWORK VIA WIRELESS LOCAL AREA NETWORK

(71) Applicant: Verizon Patent and Licensing Inc., Basking Ridge, NJ (US)

(72) Inventors: Chien-Yuan Huang, Basking Ridge, NJ (US); Amir Hossein Khastoo, Renton, WA (US); Suzann Hua, Beverly Hills, CA (US); Glenda T. Baloto, San Ramon, CA (US)

(21) Appl. No.: 18/441,043

(22) Filed: Feb. 14, 2024

(51) Int. Cl. H04W 12/06; H04W 76/10

(52) U.S. Cl. CPC H04W 12/06; H04W 76/10

(57) ABSTRACT

A device may be hosted by a cellular network. The device may include a processor. The processor may be configured to: receive a request from a User Equipment device (UE) to connect to the cellular network; and determine whether the UE includes a Fifth Generation (5G) Non-Standalone (NSA) device or a 5G Standalone (SA) device. If the UE is determined to include a 5G NSA device, the processor may perform a Fourth Generation (4G) authentication via 4G core network components included in the cellular network; and if the UE is determined to include a 5G SA device, the processor may perform a 5G authentication via 5G core network components included in the cellular network. When the 4G authentication or the 5G authentication is successful, the processor may establish a session with an endpoint in the cellular network.

### BACKGROUND INFORMATION

During initial deployment of Fifth Generation (5G) New Radio (NR) networks, many mobile network operators (MNOs) built their 5G networks using a combination of Fourth Generation (4G) network equipment and 5G network equipment based on a 5G non-standalone (NSA) network architecture. In a 5G non-standalone network architecture, a 5G radio access network (RAN) interoperates with 4G Long Term Evolution (LTE) RAN, a 4G core network, and/or a 5G core network. Many of today's mobile devices (e.g., a smart phone) may include 5G SA devices (e.g., devices capable of connecting to and receiving services from a 5G SA network) or 5G NSA devices (e.g., devices capable of communicating to and receiving services from a 5G NSA network).

### BRIEF DESCRIPTION OF THE DRAWINGS

FIG. 1 illustrates an overview of an exemplary system for accessing a cellular network via a wireless local area network (WLAN).

FIG. 2 illustrates an exemplary network environment in which systems and methods described herein may be implemented, according to an implementation.

FIG. 3 depicts exemplary components, of a system, which are included in a core network and a network environment, according to an implementation.

FIG. 4 shows exemplary signaling paths through different components of a system for accessing a cellular network via a WLAN, according to an implementation.

FIGS. 5A and 5B show exemplary data paths through different components of a system for accessing a cellular network via a WLAN, according to an implementation.

FIG. 6 shows a flow diagram of an exemplary process that is associated with accessing a cellular network via a WLAN, according to an implementation.

FIGS. 7A and 7B show exemplary messages that are exchanged by network components during a process for accessing a cellular network via a WLAN, according to an implementation.

FIG. 8 depicts exemplary components of an exemplary network device according to an implementation.

### DETAILED DESCRIPTION

The following detailed description refers to the accompanying drawings. The same reference numbers in different drawings may identify the same or similar elements. As used herein, the terms “service provider” and “provider network” may refer to, respectively, a provider of communication services and a network operated by the service provider. The network may be a cellular network. A cellular network may be uniquely identified by a Public Land Mobile Network (PLMN) Identifier (ID).

The systems and methods described herein relate to accessing a cellular network via a wireless local area network (WLAN). More specifically, the systems and methods permit both Fifth Generation (5G) Standalone (SA) devices and 5G Non-Standalone (NSA) devices that are wirelessly attached a WLAN to access a cellular network via the WLAN. Currently, 5G NSA devices and 5G SA devices may use different mechanisms to access a 5G NSA network and a 5G SA network, respectively. For example, when a 5G NSA device attaches to a WLAN, the 5G NSA device may access a cellular network through an evolved Packet Data Gateway (ePDG) within the cellular network. In contrast, when a 5G SA device attaches to a WLAN, the 5G SA device may access a cellular network through a Non-Seamless Wireless Offload (NSWO) device. To render services to both 5G NSA and SA devices, therefore, the systems described herein include ePDGs and NSWOs, both modified to permit the ePDGs and the NSWOs to interoperate.

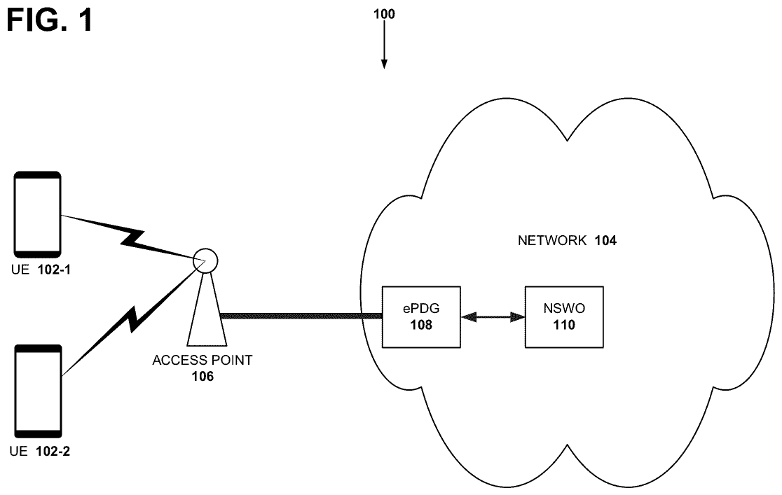

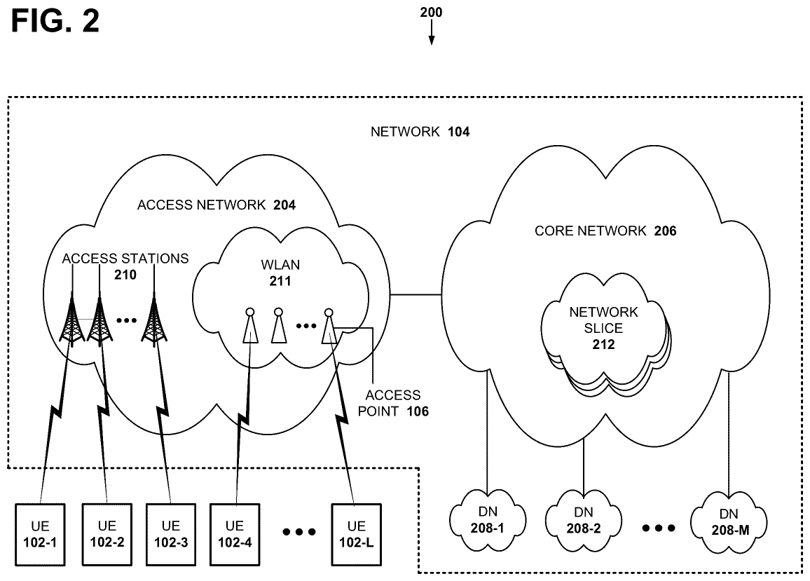

FIG. 1 illustrates an overview of an exemplary system 100 for accessing a cellular network via a WLAN. As shown, system 100 may include User Equipment devices (UE) 102-1 and 102-2 (e.g., mobile devices such as smart phones), a cellular network 104 (or simply referred to as network 104), a wireless access point device 106 included in a WLAN (not shown in FIG. 1), and a NSWO device (NSWO) 110. These components are described below in greater detail with reference to FIGS. 2-6, 7A, and 7B. Assume that UE 102-1 includes a 5G NSA device and that UE 102-2 includes a 5G SA device. UE 102-1 may or may not include the capability to notify ePDG 108 that UE 102-1 is a 5G NSA device. UE 102-2 includes the capability to notify ePDG 108 that UE 102-2 is a 5G SA device.

When UE 102-1 attaches to the WLAN via access point device 106 (e.g., a WI-FI access point device), UE 102-1 may send a message to ePDG 108, requesting a connection to network 104. If UE 102-1 does not identify itself as a 5G NSA device, ePDG 108 may assume that UE 102-1 includes a 5G NSA device and may follow a Fourth Generation (4G) or Long-Term Evolution (LTE) authentication procedure that involves 4G or LTE core network components of system 100. If the authentication is successful, UE 102-1 may then establish an IPSec tunnel with ePDG 108 and a session with another endpoint in network 104. Thus, system 100 may permit UE 102-1 (e.g., 5G NSA device) to access cellular network 104 and its services via the WLAN.

Similarly, when UE 102-2 attaches to the WLAN via access point device 106, UE 102-2 may send a message to ePDG 108, requesting a connection to network 104. In contrast to UE 102-1, however, UE 102-2 indicates that UE 102-2 includes a 5G SA device. Upon receipt of the 5G SA device indication from UE 102-2, ePDG 108 may request an NSWO 110 to 5G authenticate UE 102-2. Next, NSWO 110 may follow a 5G authentication procedure that involves UE 102-2 and 5G core (5GC) components of system 100. If the 5G authentication is successful, UE 102-2 may establish an IPSec tunnel with ePDG 108 and a session with another endpoint in network 104. Thus, system 100 permits UE 102-2 (e.g., 5G SA device), as well as UE 102-1 (e.g., 5G NSA device), to access cellular network 104 via the WLAN.

FIG. 2 illustrates an exemplary network environment 200 in which system 100 and methods associated with system 100 may be implemented. As shown, network environment 200 may include UEs 102-1 through 102-L (collectively referred to as UEs 102 and generically as UE 102), an access network 204, a core network 206, and data networks 208-1 through 208-M (collectively referred to as data networks 208 and generically as data network 208). Access network 204, core network 206, and data networks 208 may be part of cellular network 104.

UE 102 may include a wireless communication device. Examples of UE 102 include: a smart phone; a tablet device; a wearable computer device (e.g., a smart watch); a global positioning system (GPS) device; a laptop computer; a media playing device; a portable gaming system; an Internet-of-Things (IoT) device, etc. In some implementations, UE 102 may correspond to a wireless Machine-Type-Communication (MTC) device that communicates with other devices over a machine-to-machine (M2M) interface, such as LTE-M or Category M1 (CAT-M1) devices and Narrow Band (NB)-IoT devices.

When a UE 102 attaches to a WLAN (e.g., a WLAN 211), the UE 102 may send a request to ePDG 108 to connect to network 104. Depending on whether UE 102 includes a 5G NSA device or a 5G SA device, UE 102 may behave differently in requesting ePDG 108 to permit UE 102 to access network 108. For example, when UE 102 is implemented as a 5G NSA device, UE 102 may or may not provide, in the request, an indication that UE 102 includes a 5G NSA device. In contrast, when UE 102 is implemented as a 5G SA device, UE 102 may provide, in the request, an indication that UE 102 includes a 5G SA device. Whether UE 102 includes a 5G NSA device or a 5G SA device, after sending the request to ePDG 108, UE 102 may authenticate at network 104 via ePDG 108 and establish a session with an endpoint located in network 104. If UE 102 includes a 5G NSA device, the endpoint may include another UE 102, a component in access network 204 (e.g., a Multi-access Edge Computing (MEC) cluster, a component in core network 206, or a component in data network 208. If UE 102 includes a 5G SA device, the endpoint may include another UE 102, a MEC cluster, a component in core network 206, a component in a network slice 212 (described below), or a component in data network 208.

Access network 204 may include a 5G New Radio (NR) network, an LTE radio network, an LTE-Advanced radio network, or another type of radio network. These networks may include many central units (CUs), distributed units (DUs), radio units (RUS), and access stations, which are illustrated in FIG. 2 as access stations 210 for establishing and maintaining over-the-air broadband channels with UEs 102. Each access station 210 may include a 4G, 5G, or another type of base station (e.g., eNB, gNB, etc.) that comprises one or more radio frequency (RF) transceivers. In some implementations, access station 210 may be part of an evolved Universal Mobile Telecommunications Service (UMTS) Terrestrial Network (eUTRAN).

Access network 204 may include, in addition to radio access networks (RANs), other networks via which UE 102 may access core network 206. For example, access network 204 may include various IP networks, such as the Internet, or WLANs, such as a WLAN 211. WLAN 211 may include a wireless local area network whose components operate in accordance with various Institute of Electrical and Electronics Engineering (IEEE) 802.11 protocols. WLAN 211 may include devices that use radio waves to communicate in, for example, 2.4 GHz band and/or 5 GHz band, as well as other wired network devices, such as Ether net devices. As shown, WLAN 211 may include one or more access point devices, such as a wireless access point device 106, to which UEs 102 may attach wirelessly. Once UE 102 attaches to WLAN 211 via access point device 106, UE 102 may forward a request to ePDG 108 via one or more networks (e.g., the Internet) to request a session with network 104.

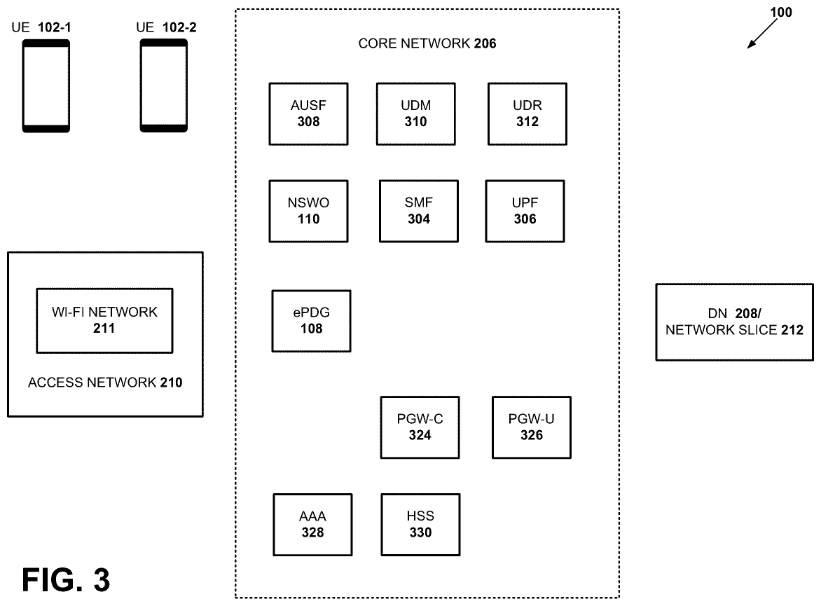

Core network 206 may include one or more devices and network components for providing communication services to UEs 102. For example, core network 206 may permit UEs 102 to attach to network 104, establish sessions with devices in network 104, and/or receive services from network 104 (e.g., receive content, access the Internet, conduct video conferences with other UEs 102 attached to network 104). To deliver services, core network 206 may interface with other networks, such as data networks 208. To render these services and to perform the core functions of network 104, core network 206 may include 5G core network components or 4G core network components. Some of these components, which may include ePDG 108 and NSWO 110 (shown in FIG. 1 but not in FIG. 2), are described below in greater detail with reference to FIGS. 3-7B.

As further shown, core network 206 may include one or more of network slice 212 (collectively referred to network slices 212 and generically referred to as network slice 212). Depending on the implementation, network slice 212 may be implemented within other networks, such as access network 204 and/or data networks 208. Access network 204, core network 206, and data networks 208 may include multiple instances of network slices 212. Each network slice 212 may be instantiated as a result of network slicing, which involves a form of virtual network architecture that enables multiple logical networks to be implemented on top of a shared physical network infrastructure using software defined networking (SDN) and/or network function virtualization (NFV). Each logical network, referred to as a “network slice,” may encompass an end-to-end virtual network with dedicated storage and/or computational resources that include access network components, clouds, transport components, Central Processing Unit (CPU) cycles, memory, etc. Furthermore, each network slice 212 may be configured to meet a different set of requirements and may be associated with a particular Quality-of-Service (QoS) Class Identifier (QCI), 5G QoS Identifier (5Q1), and/or a particular group of enterprise customers associated with communication devices.

Network slices 212 may be capable of supporting enhanced Mobile Broadband (eMBB) traffic, Ultra Reliable Low Latency Communication (URLLC) traffic, Time Sensitive Network (TSN) traffic, Massive IoT (MIoT) traffic, Vehicle-to-Everything (V2X) traffic, High performance Machine Type Communication (HMTC) traffic, and other customized traffic, for example. Each network slice 212 may be associated with an identifier, herein referred to as a Single Network Slice Selection Assistance Information (S-NSSAI) and/or a network slice instance ID. Many components in core network 206 may manage S-NSSAIs (or simply NSSAI).

Data networks 208 may include one or more networks connected to core network 206. In some implementations, a particular data network 208 may be associated with a data network name (DNN) in 5G and/or an Access Point Name (APN) in 4G. UE 102 may request a connection to data network 208 using a DNN or APN. Each data network 208 may include and/or be connected to a local area network (LAN), a wide area network (WAN), a metropolitan area network (MAN), an autonomous system on the Internet, an optical network, a cable television network, a satellite network, another wireless network (e.g., a Code Division Multiple Access (CDMA) network, a general packet radio service (GPRS) network, and/or an LTE network), a telephone network (e.g., the Public Switched Telephone Network (PSTN) or a cellular network), an intranet, an ad hoc network, or a combination of networks.

For clarity, FIG. 2 does not show all components that may be included in network environment 200 (e.g., routers, bridges, additional networks, additional access stations 210, access point devices 106, WLANs 211, data centers, portals, etc.). Depending on the implementation, network environment 200 may include additional, fewer, different, or a different arrangement of components than those illustrated in FIG. 2. Furthermore, in different implementations, the configuration of network environment 200 may be different.

FIG. 3 depicts exemplary components, of system 100, which are included in core network 206 and network environment 200, according to an implementation. As shown, core network 206 may include ePDG 108, NSWO 110, a Session Management Function (SMF) 304, a User Plane Function (UPF) 306, an Authentication Server Function (AUSF) 308, a Unified Data Management (UDM) 310, and a Unified Data Repository (UDR) 312, a Packet data network Gateway-Control Plane (PGW-C) 324, a PGW-User Plane (PGW-U) 326, an Authentication Authorization and Accounting server (AAA) 328, and a Home Subscriber Server 330. In some implementations, NSWO 110, SMF 304, UPF 306, AUSF 308, UDM 310, and UDR 312 may be part of and be included in a 5G core (5GC); and ePDG 108, PGW-C 324, PGW-U 326, AAA 328, and HSS 330 may be part of and be included in a 4G core (e.g., Evolved Packet Core (EPC)). FIG. 3 also shows UEs 102-1 and 102-2, access network 204, and WLAN 211, which have been described above with reference to FIGS. 1 and 2. Depending on the implementation, core network 206 may include additional, fewer, or different components than those illustrated in FIG. 3.

ePDG 108 may provide access to network 104 to UEs 102 attached to WLAN 211. ePDG 108 may be capable of setting up an IPSec tunnel between UE 102 and ePDG 108. To set up an IPSec tunnel, ePDG 208 may apply, within the framework of Extensible Authentication Protocol (EAP), the Internet Key Exchange protocol version 2 (IKEv2), and Authentication and Key Agreement protocols (EAP-AKA and EAP-AKA′). EAP-AKA and EAP-AKA′ may provide mechanisms for exchanging keys and establishing secure communication channels between UEs 102 and network 104. ePDG 108 may provide communications from UE 102 (e.g., via an IPSec tunnel) to other components in core network 206 using interfaces specific to the components of core network 206.

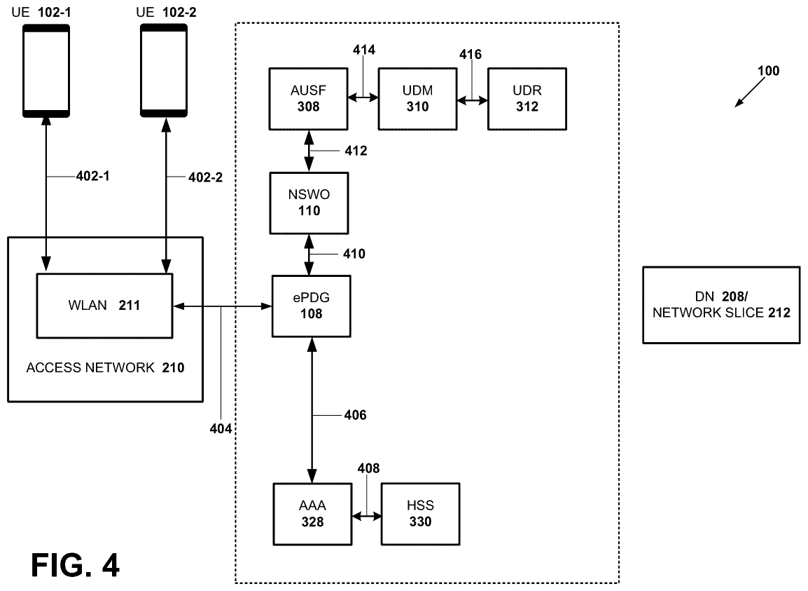

NSWO 110 may include capability to authenticate UE 102 attached to WLAN 108 using 5G credentials. NSWO 110 may apply EAP-AKA′ to UE-provided credentials and subscriber data from UDM 310 and/or UDR 312. ePDG 108 and NSWO 110 may provide the above-described capabilities via modifications to standard interfaces and/or addition of new interfaces. These capabilities for enabling UE 102 to access cellular network 104 via WLAN 211 are described below in greater detail with reference to FIGS. 4-7B.

SMF 304 may: perform session establishment, modification and/or release; perform IP address allocation and management; perform Dynamic Host Configuration Protocol (DHCP) functions; perform selection and control of UPF 306; configure traffic steering at UPF 306 to guide traffic to the correct destination; terminate interfaces toward a Policy Control Function (PCF); perform lawful intercepts; charge data collection; support charging interfaces; control and coordinate charging data collection; terminate session management parts of Non-Access Stratum (NAS) messages; perform downlink data notification; manage roaming functionality; and/or perform other types of control plane processes for managing user plane data.

UPF 306 may perform the following: maintain an anchor point for intra/inter-Radio Access Technology (RAT) mobility (e.g., mobility across different radio access technologies); maintain an external Packet Data Unit (PDU) point of interconnect to a data network (e.g., an IP network, etc.); perform packet routing and forwarding; perform the user plane part of policy rule enforcement; perform packet inspection; perform lawful intercept; perform traffic usage reporting; perform Quality-of-Service (QoS) handling in the user plane; perform uplink traffic verification; perform transport level packet marking; perform downlink packet buffering; send an “end marker” to a Radio Access Network node (e.g., access station 210) or ePDG 108; and/or perform other types of user plane processes.

AUSF 308 may provide authentication and authorization services to 5GC components of core network 206. For authentication, AUSF 308 may verify the subscriber's identity and determine whether UE 102 has provided the correct credentials to access network 104. For authorization, AUSF 308 may determine whether UE 102 has the authority to access specific network functions or services. According to an embodiment, AUSF 3308 may support Authentication and key agreement (AKA) protocol (e.g., EAP-AKA and/or EAP-AKA′).

UDM 310 may: maintain subscription information for UE 102; manage subscriptions; generate authentication credentials; handle user identification; perform access authorization based on subscription data; perform network function registration management; maintain service and/or session continuity by maintaining assignment of SMF 304 for ongoing sessions; support Short Messaging Service (SMS) message delivery; support lawful intercept functionality; and/or perform other processes associated with managing user data. For example, UDM 310 may store subscription profiles that include authentication, access, and/or authorization information. Each subscription profile may include: information identifying UE 102; authentication and/or authorization information for UE 102; information identifying services enabled and/or authorized for UE 102; device group membership information for UE 102; and/or other types of information associated with UE 102. Furthermore, the subscription profile may include mobility category information associated with UE 102. UDR 312 may store subscriber/subscription data (e.g., subscriber/subscription profile) associated with UEs 102, retrieve subscriber data, modify subscriber data, and/or delete subscriber data.

PGW-C 324 may provide control plane operations for UE traffic in network 104. The functionalities of PGW-C 324 may include, for example, UE 102 authentication, mobility management for UEs 102, management of QoS policy enforcement, management of enforcement of charging and policy rules; and management of Packet Data Network (PDN) sessions between PGW-U 326 and UEs 102.

PGW-U 326 may act as a gateway from core network 206 into data network 208. The functionalities of PGW-U 326 may include, for example, managing uplink/downlink UE data; allocating Internet Protocol (IP) addresses; to UEs 102; enforcing QoS policies for UE traffic of various types (e.g., video, audio, etc.); performing deep packet inspections to take appropriate security measure (e.g., block traffic from a particular UE 102); facilitating mobility management of UE 102; maintaining data connection to UEs 102 and redirecting UE 102 traffic during UE 102 transit; and aiding Policy and Charging Rules Function (PCRF) in enforcing policy rules and charging rules. The role of PGW-U 326 among EPC components of system 100 may be similar to that of UPF 306 among 5GC components of system 100.

AAA 328 may perform authentication of UEs 102, authorization of UEs 102 to receive services or access resources, and accounting for the use of services and resources by UEs 102. For UE 102 authentication, AAA 328 may verify the identity of UE 102 (or the user of UE 102) attempting to access network 104 based on the security credentials provided by UE 102 and checked against information stored at HSS 330 or UDR 312. For authorization of UE 102, AAA 328 may determine whether UE 102 has the permission to access the particular service or resource (e.g., identified by UE 102 or by network 104) based on information from UE 102 and HSS 330. For accounting, AAA 328 may record UE activities (e.g., data usage, service usage, etc.). Accounting records may be used for billing, troubleshooting, maintenance, etc. AAA 328 may support EAP-AKA′. HSS 330 may store and retrieve UE subscription information for EPC components in system 100, such as AAA 328 and PGW-C 324. For EPC components of system 100, HSS 330 may provide functionalities that are similar to those performed by UDM 308 and UDR 310 for 5GC components of system 100.

FIG. 4 shows exemplary signaling paths through different components, of system 100 illustrated in FIG. 3, for accessing a cellular network 104 via WLAN 211. Assume that UE 102-1 includes a 5G NSA device and UE 102-2 includes a 5G SA device. Components of system 100 may exchange various messages over the signaling paths when UEs 102-1 and 102-2 attempt to access network 104.

When UE 102-1 attempts to receive services from network 104, UE 102-1 may send, to ePDG 108, a request to establish a session (arrows 402-1 and 404). In one implementation, the request may include an Information Element (IE) that indicates whether UE 102-1 includes a 5G NSA device. When ePDG 108 receives the request, ePDG 108 may conclude that UE 102-1 includes a 5G NSA device based on either the IE or the absence of the IE in the request. Upon determining that UE 102-1 includes a 5G NSA device, ePDG 108 may initiate a 4G or LTE authentication of UE 102, by forwarding an authentication request for UE 102-1 to AAA 328 and receiving authentication reply for UE 102-1 from AAA 328 via an SWm interface between ePDG 108 and AAA 328 (arrow 406). In order for AAA 328 to respond to the request from ePDG 108 and to authenticate and/or authorize UE 102-1, AAA 328 may obtain security credentials for UE 102-1 and subscriber information from HSS 330 via an SWx interface between AAA 328 and HSS 330 (arrow 408). When ePDG 108 receives the result of the authentication from AAA 328, ePDG 108 and UE 102-1 may exchange additional messages (e.g., IKEv2-AKA challenge messages) to create an IPSec tunnel between UE 102-1 and ePDG 108 and then to establish the PDN session requested by UE 102. The PDN session may be established over a data path between UE 102-1 and an endpoint in network 104 (e.g., data network 208) for UE 102-1 to access cellular network 104 via WLAN 211.

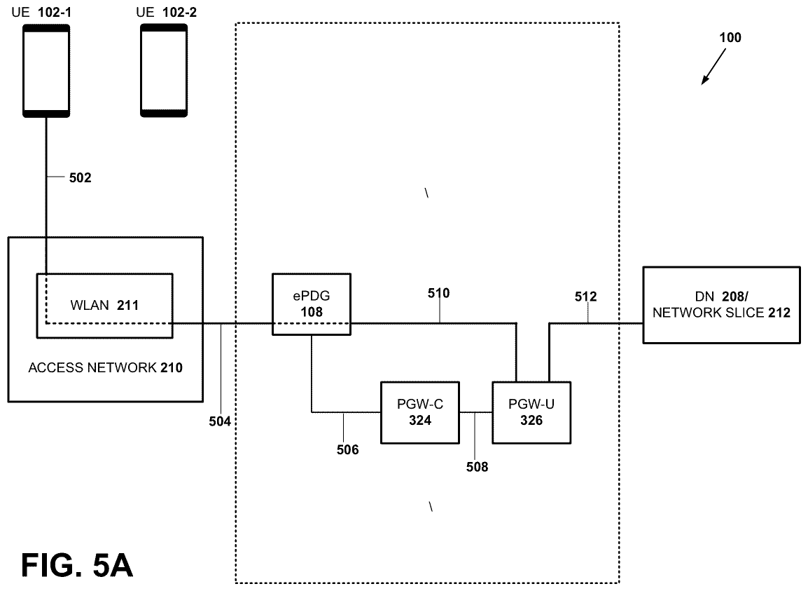

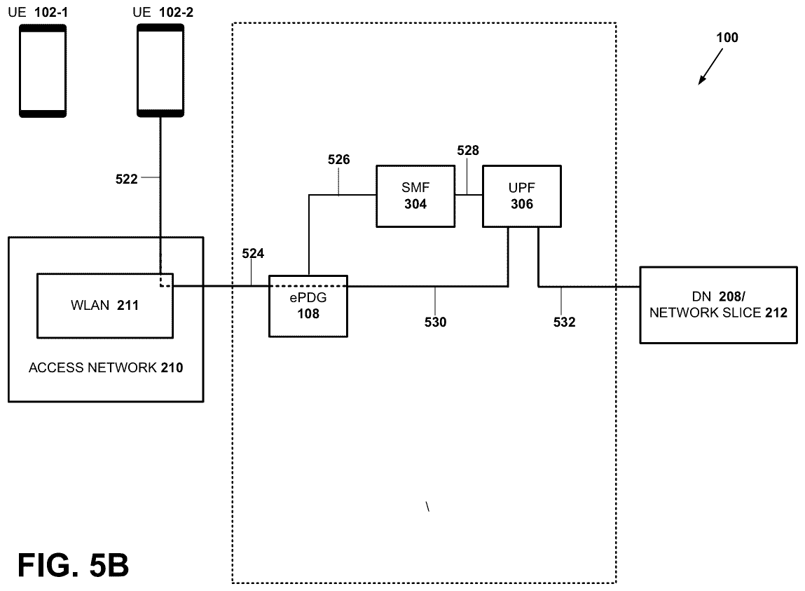

FIG. 5A shows an exemplary data path through EPC components of system 100 for UE 102-1 to access cellular network 104 via WLAN 211. As noted above, after exchanging messages, ePDG 108 and UE 102-1 may construct an IPSec tunnel. The IPsec tunnel may be established over path segments 502 and 504 between UE 102-1 and ePDG 108. Next, ePDG 108 may send PDN session establishment request messages to PGW-C 324 (506). In turn, PGW-C 324 may configure PGW-U 326, via messages (508), to establish a PDN session that extends from UE 102-1 to data network 208 through PGW-U 326, over paths 502, 504, 510, and 512. After the session establishment, UE 102-1 may receive services from network 104 via WLAN 211.

Referring back to FIG. 4, when UE 102-2 attempts to receive services from network 104, UE 102-2 may send, to ePDG 108, a request to establish a session (arrows 402-2 and 404). In one implementation, the request may include an IE that indicates whether UE 102-1 includes a 5G SA device. When ePDG 108 receives the request, ePDG 108 may conclude that UE 102-2 includes a 5G SA device based on the IE. Upon determining that UE 102-2 includes a 5G SA device, ePDG 108 may initiate a 5G authentication, by forwarding an authentication request for UE 102-2 to NSWO 110 (arrow 410). The request may include a UE identifier, such as a Subscription Concealed Identifier (SUCI).

In one implementation, ePDG 108 may make the request to NSWO 110 via an interface designed for ePDG 108 and NSWO 110 to exchange UE authentication-related messages. In particular, ePDG 108 may send a Diameter EAP-Request (DER) by using the interface. When NSWO 110 receives the DER, NSWO 110 may use an Nausf interface of AUSF 308 (arrow 412) to request AUSF 308 to authenticate UE 102-2. Like the DER, the request may include a UE identifier. Next, in response to the request, AUSF 308 may query UDM 310 via an Nudm interface to obtain UE credentials-related data and subscription profile data (arrow 414). When AUSF 308 obtains the information, AUSF 308 may verify the identity of UE 102-2 and return the result of the verification to NSWO 110, which in turn may relay the result to ePDG 108. ePDG 108 and UE 102-2 may exchange additional messages (IKE-AKA′ challenge messages) to establish an IPSec tunnel between UE 102-2 and ePDG 108 and then to establish a PDU session requested by UE 102. The PDU session may be established over a data path between UE 102-1 and an endpoint in network 104 (e.g., data network 208 or network slice 212) for UE 102-2 to access cellular network 104 via WLAN 211.

FIG. 5B shows an exemplary data path through 5GC components of system 100 for UE 102-2 to access cellular network 104 via WLAN 211. As noted above, after exchanging IKE-AKA′ messages, ePDG 108 and UE 102-2 may construct an IPSec tunnel. The IPsec tunnel may be established over path segments 522 and 524 between UE 102-2 and ePDG 108. Next, ePDG 108 may send session establishment request messages to SMF 304 (Sb2 interface on segment 526). In turn, SMF 304 may instruct UPF 308 via messages over a segment 528 (N4 interface), to establish a PDU session that extends from UE 102-2 to data network 208 or network slice 212 via UPF 306, over a data path that comprises segments 522, 524, 530, and 532. After the establishment, UE 102-2 may receive services from network 104 via WLAN 211.

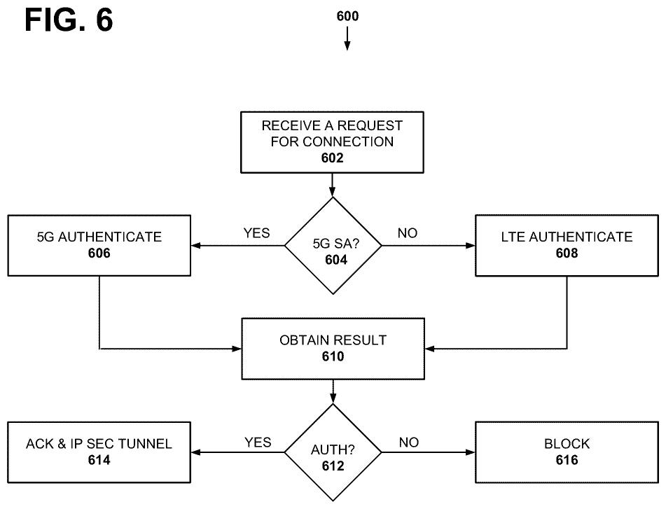

FIG. 6 shows a flow diagram of an exemplary process 600 that is associated with accessing a cellular network 104 via WLAN 211, according to an implementation. Process 600 may be performed by various network components illustrated in FIGS. 1-3, such as UE 102, access network 204, core network 206, data network 208, network slice 212, access point device 106, ePDG 108, NSWO 110, SMF 304, UPF 306, AUSF 308, UDM 310, UDR 312, PGW-C 324, PGW-U 326, AAA 328, and HSS 330.

As shown, process 600 may include ePDG 108 receiving a request for network connection from UE 102 via WLAN 211 in access network 204 (block 602). In response to the request, ePDG 108 may determine whether the request includes an IE that indicates whether UE 102 is a 5G SA device (block 604). If there is an IE, in the request, that indicates UE 102 is a 5G SA device (block 604: YES), ePDG 108 may perform 5G authentication of UE 102 via NSWO 110, as described above with reference to FIG. 4 (block 606). Process 600 may then proceed to block 610.

At block 604, if the request for connection does not include an IE which indicates that UE 102 is a 5G SA device or includes an IE which indicates that UE 102 is a 5G NSA device (block 604: NO), ePDG 108 may perform LTE authentication of UE 102 via AAA 328, as described above with reference to FIG. 4 (block 608). Process 600 may proceed to block 610.

At block 610, ePDG 108 may obtain the result of authenticating UE 102. If ePDG 108 determines that UE 102 is successfully authenticated (block 612: YES), ePDG 108 may send an acknowledgement to UE 102 and construct an IPSec tunnel between UE 102 and ePDG 108 (block 614). Furthermore, if UE 102 includes a 5G NSA device, ePDG may establish a PDN session between UE 102 and an endpoint in network 104 (e.g., a component in data network 208), as described above with reference to FIG. 5A. If UE 102 includes a 5G SA device, ePDG 108 may establish a PDU session between UE 102 and an endpoint in network 104 (e.g., a component on network slice 212 or in data network 208). At block 612, if UE 102 is not successfully authenticated (block 612: NO), ePDG 108 may block UE 102 from connecting to network 104 (block 616).

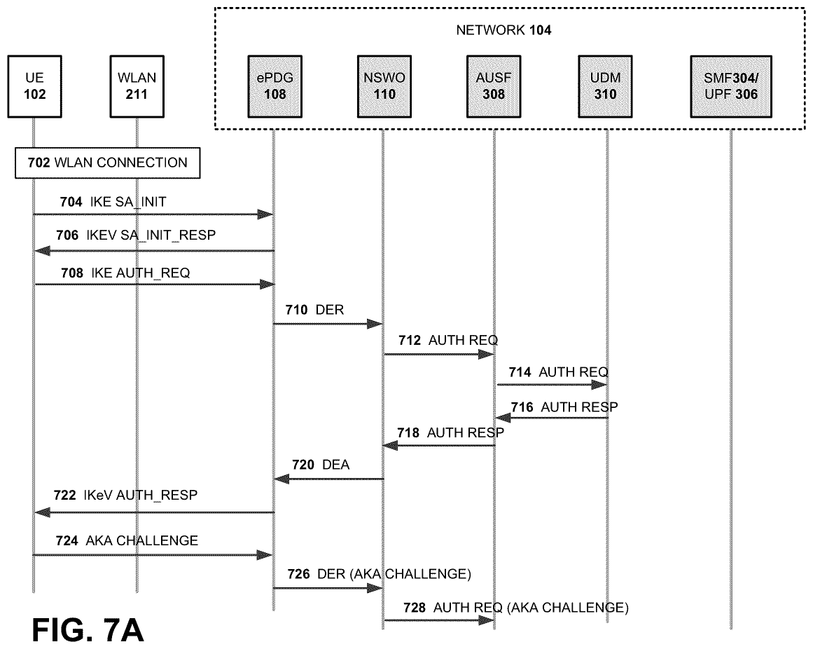

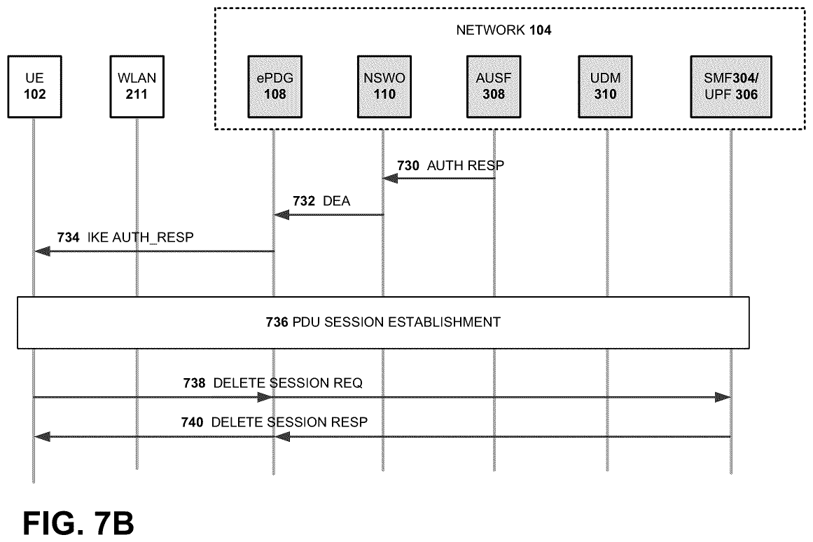

FIGS. 7A and 7B show exemplary messages that are exchanged by network components of system 100 during process 600, according to an implementation. As shown, UE 102 may establish a connection with WLAN 211 (block 702). After UE 102 attaches to WLAN 211, UE 102 may send a request to ePDG 108 to connect to network 104. The request may include, for example, an IE with an IKE_SA_INIT flag, to indicate that UE 102 includes a 5G SA device (arrow 704). When ePDG 108 receives the IE, ePDG 108 may determine that the UE 102 requesting the connection includes a 5G SA device, and accordingly, may send a reply with an indication, such as IKE_SA_INIT_RESP flag (arrow 706). The IKE_SA_INIT_RESP flag may acknowledge that ePDG 108 received the IKE_SA_INIT flag.

When UE 102 receives response 706 from ePDG 108, UE 108 may request ePDG 108 to authenticate UE 102, with IKE authentication request (arrow 708). The request may include an ID of the UE, such as a SUCI. In response, having already determined that UE 102 includes a 5G SA device, ePDG 108 may issue a Diameter EAP Request (DER) to NSWO 110, along with the UE ID (arrow 710). In turn, NSWO 110 may send an authentication request (along with the UE ID, such as the SUCI) to AUSF 308 via an Nausf interface (e.g., Nausf_UEAuthentication Authentication_Request (SUCI, NSWO_Indication), where NSWO_Indication signifies that NSWO 110 is requesting the authentication) (arrow 712). To authenticate the UE 102, AUSF 308 may request a transformed UE authentication vector from UDM 310 via an Nudm interface (e.g., an Nudm_UEAuthentication Get_Request (SUCI, NSWO_Indication) interface) (arrow 714). UDM 310 may then access UDR 312 to retrieve any information it needs and perform processing to obtain a transformed authentication vector-EAP AKA′ and a Subscriber Permanent Identity (SUPI). Next, UDM 310 may pass the transformed authentication vector to AUSF 308 via am Nudm interface (e.g., Nudm_UEAuthentication Get_Response (SUPI, EAP_AKA′) (arrow 716).

When AUSF 308 receives the transformed authentication vector, AUSF 308 may pass the transformed vector to NSWO 110 (arrow 718), via an Nausf interface (e.g., Nausf_UEAuthentication Authentication_Response (SUPI, EAP-AKA′)). In response, NSWO 110 may pass EAP_AKA′ to ePDG 108 as a Diameter EAP Answer (DEA) (arrow 720). ePDG 108 may relay the authentication response to UE 102 (arrow 722), along with IKE AKA′.

Upon receiving IKE_AKA′, UE 102 may respond to an authentication challenge, sending an additional credentials and AKA′ challenge to ePDG 108 (arrow 724). ePDG 108 may send a DER with AKA′ challenge to NSWO 110 (arrow 726), which in turn may send an authentication challenge response to AUSF 110 via the Nausf interface (e.g., Nausf UEAuthentication Authentication_Request (AKA′ challenge) (arrow 728). AUSF 308 may then evaluate the response to the challenge and return the result of the evaluation to NSWO 110 via Nausf_UEAuthentication Authentcation_Response (arrow 730, FIG. 7B). If the challenge was met successfully, the response may include a master session key (MSK). NSWO 110 may relay the result of the challenge to ePDG 108 via DEA (arrow 732), passing the MSK. ePDG 108 may then notify UE 102 with an IKE challenge response that includes the MSK (arrow 734). Having successfully met the challenge, UE 102 then may establish a session with network 104 via ePDG 108, core network components, and the endpoint (not shown) (bock 736). When UE 102 is done with the session, UE 102 may terminate the session by sending a request to delete the session to ePDG 108, which may then satisfy the request in coordination with core network components and the endpoint (arrows 738). Once the session is terminated, ePDG 108 may send a response message to UE 102 (arrow 740).

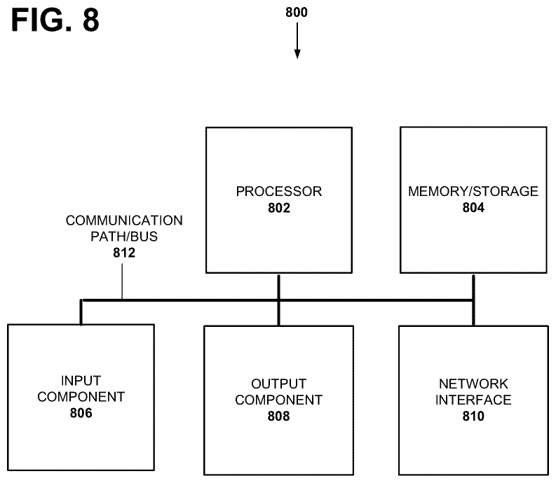

FIG. 8 depicts exemplary components of an exemplary network device 800. Network device 800 may correspond to or be included in any of the devices and/or components illustrated in FIGS. 1-5, 7A, and 7B (e.g., UE 102, access network 204, core network 206, data network 208, ePDG 108, NSWO 110, SMF 304, UPF 306, AUSF 308, UDM 310, UDR 312, PGW-C 324, PGW-U 326, AAA 328, HSS 330, etc.). In some implementations, network devices 800 may be part of a hardware network layer on top of which other network layers and NFs may be implemented. As shown, network device 800 may include a processor 802, memory/storage 804, input component 806, output component 808, network interface 810, and communication path 812. In different implementations, network device 800 may include additional, fewer, different, or different arrangement of components than the ones illustrated in FIG. 8. For example, network device 800 may include line cards, switch fabrics, modems, etc.

Processor 802 may include a processor, a microprocessor, an Application Specific Integrated Circuit (ASIC), a Field Programmable Gate Array (FPGA), programmable logic device, chipset, application specific instruction-set processor (ASIP), system-on-chip (SoC), central processing unit (CPU) (e.g., one or multiple cores), microcontrollers, and/or other processing logic (e.g., embedded devices) capable of controlling network device 800 and/or executing programs/instructions.

Memory/storage 804 may include static memory, such as read only memory (ROM), and/or dynamic memory, such as random access memory (RAM), or onboard cache, for storing data and machine-readable instructions (e.g., programs, scripts, etc.).

Memory/storage 804 may also include an optical disk, magnetic disk, solid state disk, holographic versatile disk (HVD), digital versatile disk (DVD), and/or flash memory, as well as other types of storage device (e.g., Micro-Electromechanical system (MEMS)-based storage medium) for storing data and/or machine-readable instructions (e.g., a program, script, etc.). Memory/storage 804 may be external to and/or removable from network device 800.

Memory/storage 804 may include, for example, a Universal Serial Bus (USB) memory stick, a dongle, a hard disk, off-line storage, a Blu-Ray® disk (BD), etc. Memory/storage 804 may also include devices that can function both as a RAM-like component or persistent storage, such as Intel® Optane memories.

Depending on the context, the term “memory,” “storage,” “storage device,” “storage unit,” and/or “medium” may be used interchangeably. For example, a “computer-readable storage device” or “computer-readable medium” may refer to both a memory and/or storage device.

Input component 806 and output component 808 may provide input and output from/to a user to/from network device 800. Input/output components 806 and 808 may include a display screen, a keyboard, a mouse, a speaker, a microphone, a camera, a DVD reader, USB lines, and/or other types of components for obtaining, from physical events or phenomena, to and/or from signals that pertain to network device 800.

Network interface 810 may include a transceiver (e.g., a transmitter and a receiver) for network device 800 to communicate with other devices and/or systems. For example, via network interface 810, network device 800 may communicate over a network, such as the Internet, an intranet, a terrestrial wireless network (e.g., a WLAN, WI-FI, WI-MAX, etc.), a satellite-based network, optical network, etc. Network interface 810 may include a modem, an Ethernet interface to a LAN, and/or an interface/connection for connecting network device 800 to other devices (e.g., a Bluetooth interface).

Communication path 812 may provide an interface through which components of network device 800 can communicate with one another.

Network device 800 may perform the operations described herein in response to processor 802 executing software instructions stored in a non-transient computer-readable medium, such as memory/storage 804. The software instructions may be read into memory/storage 804 from another computer-readable medium or from another device via network interface 810. The software instructions stored in memory/storage 804, when executed by processor 802, may cause processor 802 to perform processes that are described herein.

In this specification, various preferred embodiments have been described with reference to the accompanying drawings. It will be evident that modifications and changes may be made thereto, and additional embodiments may be implemented, without departing from the broader scope of the invention as set forth in the claims that follow. The specification and drawings are accordingly to be regarded in an illustrative rather than restrictive sense.

In the above, while a series of blocks, messages, and signals have been described with regard to the processes and messages illustrated in FIGS. 6, 7A, and 7B, the order of the blocks and messages may be modified in other implementations. In addition, non-dependent blocks and messages may represent actions and messages that can be performed or sent in parallel and in different order.

As used above, the term “session” may refer to a series of communications, of a limited duration, between two endpoints (e.g., two applications). When a session is established between an application and a network or a network slice, the session is established between the application and another application/server hosted by the network or the network slice. Similarly, if a session is established between a device and a network slice or a network, the session is established between an application on the device and another application on either the network slice or the network.

In addition, the term “Protocol Data Unit (PDU) session” or “Packet Data Network (PDN) session” may refer to communications between a mobile device and another endpoint (e.g., a data network, a network slice, etc.). Depending on the context, the term “session” may refer to a PDU session, a PDN session, or a session between applications. Additionally, depending on the context, the term “connection” may refer to a session, a PDU session, a PDU session, or another type of connection (e.g., a radio frequency link between a device and a base station).

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

Further, certain portions of the implementations have been described as “logic” that performs one or more functions. This logic may include hardware, such as a processor, a microprocessor, an application specific integrated circuit, or a field programmable gate array, software, or a combination of hardware and software.

To the extent the aforementioned embodiments collect, store or employ personal information provided by individuals, it should be understood that such information shall be collected, stored, and used in accordance with all applicable laws concerning protection of personal information. The collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, block, or instruction used in the present application should be construed as critical or essential to the implementations described herein unless explicitly described as such. Also, as used herein, the articles “a,” “an,” and “the” are intended to include one or more items. Further, the phrase “based on” is intended to mean “based, at least in part, on” unless explicitly stated otherwise.

What is claimed is:

1. A device included in a cellular network, comprising:
a processor configured to:
receive a request from a User Equipment device (UE) to connect to the cellular network;
determine whether the UE includes a Fifth Generation (5G) Non-Standalone (NSA) device or a 5G Standalone (SA) device;
if the UE is determined to include a 5G NSA device,
perform a Fourth Generation (4G) authentication via 4G core network components included in the cellular network;
if the UE is determined to include a 5G SA device,
perform a 5G authentication via 5G core network components included in the cellular network; and
when the 4G authentication or the 5G authentication is successful, establish a session with an endpoint in the cellular network.

2. The device of claim 1, wherein the request includes an information element that indicates that the UE includes a 5G SA device.

3. The device of claim 1, wherein when determining, the processor is configured to:
determine that the UE includes a 5G NSA device if the device does not receive, from the UE, an information element which indicates that the UE includes a 5G SA device.

4. The device of claim 1, wherein when performing the 4G authentication, the processor is configured to:
perform the 4G authentication via an Authentication Authorization and Accounting server (AAA) and a Home Subscriber Server (HSS).

5. The device of claim 1, wherein when performing the 5G authentication, the processor is configured to:
perform the 5G authentication via a Non-seamless Wireless Local Area Network Offload device (NSWO), an Authentication Server Function (AUSF), and a United Data Management device (UDM).

6. The device of claim 5, wherein when performing the 5G authentication via the NSWO, the AUSF, and the UDM, the processor is configured to:
send a Diameter Extensible Authentication Protocol Request (DER) to the NSWO.

7. The device of claim 6, wherein the DER includes a Subscriber Concealed Identifier (SUCI).

8. The device of claim 1, wherein when establishing the session, the processor is configured to:
establish a session between the UE and a network slice included in the cellular network.

9. The device of claim 1, wherein when establishing the session, the processor is configured to:
establish an Internet Protocol security (IPsec) tunnel between the UE and the device; and
establish a Protocol Data Unit (PDU) session between the UE and the endpoint or a Packet Data Network (PDN) session between the UE and the endpoint.

10. A method comprising:
receiving, by a device included in a cellular network, a request from a User Equipment device (UE) to connect to the cellular network;
determining whether the UE includes a Fifth Generation (5G) Non-Standalone (NSA) device or a 5G Standalone (SA) device;
if the UE is determined to include a 5G NSA device,
performing a Fourth Generation (4G) authentication via 4G core network components included in the cellular network;
if the UE is determined to include a 5G SA device,
performing a 5G authentication via 5G core network components included in the cellular network; and
when the 4G authentication or the 5G authentication is successful, establishing a session with an endpoint in the cellular network.

11. The method of claim 10, wherein the request includes an information element that indicates that the UE includes a 5G SA device.

12. The method of claim 10, when determining includes:
determining that the UE includes a 5G NSA device if an information element, which indicates the UE includes a 5G SA device, is not received from the UE.

13. The method of claim 10, wherein performing the 4G authentication includes:
performing the 4G authentication via an Authentication Authorization and Accounting server (AAA) and a Home Subscriber Server (HSS).

14. The method of claim 10, wherein performing the 5G authentication includes:
performing the 5G authentication via a Non-seamless Wireless Local Area Network Offload device (NSWO), an Authentication Server Function (AUSF), and a United Data Management device (UDM).

15. The method of claim 14, wherein performing the 5G authentication via the NSWO, the AUSF, and the UDM includes:
sending a Diameter Extensible Authentication Protocol Request (DER) to the NSWO.

16. The method of claim 15, wherein the DER includes a Subscriber Concealed Identifier (SUCI).

17. The method of claim 10, wherein establishing the session includes:
establishing a session between the UE and a network slice included in the cellular network.

18. The method of claim 10, wherein establishing the session includes:
establishing an Internet Protocol security (IPsec) tunnel between the UE and the device; and
establishing a Protocol Data Unit (PDU) session between the UE and the endpoint or a Packet Data Network (PDN) session between the UE and the endpoint.

19. A non-transitory computer-readable medium comprising processor-executable instruction, which when executed by a processor of a device included in a cellular network, cause the processor to:
receive a request from a User Equipment device (UE) to connect to the cellular network;
determine whether the UE includes a Fifth Generation (5G) Non-Standalone (NSA) device or a 5G Standalone (SA) device;
if the UE is determined to include a 5G NSA device,
perform a Fourth Generation (4G) authentication via 4G core network components included in the cellular network;
if the UE is determined to include a 5G SA device,
perform a 5G authentication via 5G core network components included in the cellular network; and
when the 4G authentication or the 5G authentication is successful, establish a session with an endpoint in the cellular network.

20. The non-transitory computer-readable medium of claim 1, wherein the request includes an information element that indicates that the UE includes a 5G SA device.
